(19) United States
(12) Patent Application Publication
(10) Pub. No.: US 2011/0087568 A1
(43) Pub. Date: Apr. 14, 2011

(54) INTEGRATED PROFILE AND PAYMENT EXCHANGE

(76) Inventor: DIPAK SHETH, Greenwich, CT (US)

(21) Appl. No.: 12/578,926

(22) Filed: Oct. 14, 2009

(51) Int. Cl. G06Q 20/00; G06Q 40/00; G06Q 10/00; G06F 15/16

(52) U.S. Cl. 705/30; 705/44; 705/40; 709/206

(57) ABSTRACT

A method for integrated profile and payment exchange, in one example embodiment, comprises receiving, via an interface with a member merchant, universal credentials to be provided by a member customer, based on the universal credentials, authenticating the member customer, each member customer having a pre-established customer account, receiving a further request to process a payment for one or more items purchased by the merchant customer from the member merchant, processing the payment by charging one or more payment instruments associated with the pre-established customer account, generating a payment record related to the payment, associating the payment record with the member merchant, selectively aggregating the payment with further payments associated with the member merchant into an aggregated payment, and making the aggregated payment into an account associated with the member merchant.

### FIELD

This application relates generally to data processing, and more specifically to computer-implemented systems and methods for integrated profile and payment exchange.

### BACKGROUND

Traditional brick and mortar businesses have lost their effectiveness and have been overshadowed by the internet commerce. The internet commerce is acting as a catalytic force which is not only rendering the traditional business practices obsolete but is also at the root of the changes in lifestyle and taste of the consumer.

As the e-commerce is becoming more prevalent, new sets of impediments are coming into the focus. For example, complexity and lack of security in transaction processing is a subject of constant frustration. There are many services which facilitate the payment for goods and services across the web. In addition to the credit card processors who process individual credit cart transactions, Internet Payment Gateway (IPG) services such as Paypal and GooglePay offer a centralized payment processing. An IPG service can make it possible for a website to sell products and/or services to a consumer and be paid as long as the customer has an account with the IPG service. The consumer account is managed by the IPG service and consumer access is secured by consumer credentials.

When a consumer is ready to check out a product or a service from a merchant website affiliated with the IPG, an Application Programming Interface (API) can transfer the customer to the IPG site for payment processing. The consumer enters the credentials to gain access to his/her account and authorizes the IPG to make payment to the merchant. The consumer is transported back to the merchant website after the payment is processed to complete the check out.

The merchant website and the IPG can use technology such as Transport Layer Security (TLS) or its predecessor, Secure Sockets Layer (SSL), cryptographic protocols that provide security and data integrity for communications over the Internet. TLS and SSL encrypt the segments of network connections at the Transport Layer end-to-end to insure the security of the transaction and personal information.

The drawback of this process is that it inhibits the growth of the internet commerce and increases the online security risk. A consumer is required to set up separate account for each merchant website. The consumer has to set up unique user ID and a password for each merchant website and enter personal, shipping and billing information.

Over time, the number of user IDs and passwords can become unmanageable and pose a significant security risk. Many consumers may even forego doing business with a new merchant simply to avoid having to set up a new account and remember a new set of user ID and password. Because a credit card processing fee is charged in every transaction, merchants may be unable to sell low priced items at profit.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In an example, a computer-implemented method comprises receiving, via an interface with a member merchant, universal credentials to be provided by a member customer, based on the universal credentials, authenticating the member customer, each member customer having a pre-established customer account, receiving a further request to process a payment for one or more items purchased by the member customer from the member merchant, processing the payment by charging one or more payment instruments associated with the pre-established customer account, generating a payment record related to the payment, associating the payment record with the member merchant, selectively aggregating the payment with further payments associated with the member merchant into an aggregated payment, and making the aggregated payment into an account associated with the member merchant. The computer-implemented method can further comprise providing a shipping address and instructions based on a customer profile, the customer profile being editable by the customer.

In an example, the pre-established customer account comprises receiving profile information associated with the member customer, receiving payment information, the payment information being associated with the one or more payment instruments, based on the profile information, verifying the payment information, and based on the verification providing the member customer with the universal credentials, the universal credentials being accepted by every member merchant. In an example, the universal credentials include a secure access key. The secure access key is a unique identifier such as an access token and/or an identification (ID)/password combination. In an example, the pre-established customer account is created via the merchant site.

In an example, becoming the member merchant comprises providing an interface to facilitate access by the member customer of a merchant site associated with the member merchant, and including the merchant site in a network of merchant sites. In an example, the one or more payment instruments include one or more of the following: a credit card, a debit card, and a back account. In an example, the pre-established account is pre-funded with the one or more of the payment instruments. In an example, the payment amount is not limited by a predetermined minimum amount.

In further examples, the above methods steps are stored on a machine-readable medium comprising instructions, which when implemented by one or more processors perform the steps. In yet further examples, subsystems or devices can be adapted to perform the recited steps. Other features, examples, and embodiments are described below.

### BRIEF DESCRIPTION OF DRAWINGS

Example embodiments are illustrated by way of example and not limitation in the figures of the accompanying drawings, in which like references indicate similar elements and in which:

FIG. 1 is a block diagram showing sample network environment within which systems and methods for integrated profile and payment exchange are implemented, in accordance with an example embodiment;

FIG. 2 is a block diagram showing an integrated profile and payment system, in accordance with an example embodiment;

FIG. 3 is a block diagram showing an integrated profile and payment system network, in accordance with an example embodiment;

FIG. 4 is a block diagram showing an integrated profile and payment system network, in accordance with an example embodiment;

FIG. 5 is a block diagram showing an integrated profile and payment system, in accordance with an example embodiment;

FIG. 6 is a flow chart showing a method for integrated profile and payment exchange, in accordance with an example embodiment; and

FIG. 7 is a diagrammatic representation of an example machine in the form of a computer system within which a set of instructions for causing the machine to perform any one or more of the methodologies discussed herein is executed.

### DETAILED DESCRIPTION

Example methods and systems for integrated profile and payment exchange are described. In the following description, for purposes of explanation, numerous specific details are set forth in order to provide a thorough understanding of example embodiments. It will be evident, however, to one skilled in the art that the present invention may be practiced without these specific details.

In some example embodiments, methods and systems for integrated profile and payment exchange can improve online business transactions efficiencies, facilitate the growth, and become a catalytic force for electronic commerce by reducing the complexity, lowering the merchant processing costs and increasing the security of transaction processing.

In some example embodiments, methods and systems for integrated profile and payment exchange (IPPEX) can provide a centralized customer database and payment-processing gateway capable of storing customer profiles and processing payment transactions. IPPEX can include a network control center accessible by customers and Merchant Member Sites (MMS) and provide a single point authentication and authorization. IPPEX can manage user and merchant profiles, activity data, and user and merchant accounts.

The IPPEX can provide an interface for customer to sign up for the service. A customer can sign up directly through a site provided by the IPPEX or through an interface provided on a MMS. A customer can open an account with IPPEX where the customer profile is created and the payment and shipping information is stored. Once the account is open, a payment instrument (e.g., Credit Card and Bank account) associated with the account can be verified, and a secure key issued to the customer. The customer can access any Member Merchant Site (MMS) with the issued key without having to enter any personal, billing and shipping information and without having to obtain a site-specific user ID and password.

To become a member, an MMS can open an account to process the transactions through IPPEX and to have each payment transaction from the MMS to be routed to IPPEX. The MMS can be given an option to have all payments processed through IPPEX or only payments associated with member customer transactions. Once the account is created, the IPPEX can provide an interface to enable the MMS to connect to the IPPEX server. As part of the interface, the MMS can utilize API provided by IPPEX to enable login through the MMS site using the key issued to the customer. When, a customer enters the key to log in on the MMS, the key is sent for authentication to the IPPEX server.

Upon a successful authentication, the customer can be allowed to log in. The customer can make one or more purchases and proceed to the check out. A payment request can be sent to the IPPEX server and, upon approval, the check out process can be completed without the customer ever having to leave the MMS. MMS can be provided a shipping address and instructions associated with the customer account thereby relieving the customer of the need to enter this information at each merchant site. The payment account associated with the customer account is charged for the payment amount and the MMS account is credited with the purchase amount less any fees.

Thus, in some example embodiments, the methods and systems for integrated profile and payment exchange can facilitate buying and selling on the Internet by making it easier and simpler for customers to make purchases. A customer can make a purchase on any MMS in the IPPEX network using a single key with the ease of going in and out of the brick and mortar store. The methods and systems for integrated profile and payment exchange can increase the marketing potential of the MMS within the context of the IPPEX system. For example, the IPPEX system can enable member customers to make quick impulse purchases.

In some example embodiments, the methods and systems for integrated profile and payment exchange enable a customer to centrally register with the network, select payment options and register payment instruments. Upon registration, the customer can utilize the key to access all MMS in the network and use the key to manage purchases through all MMS in the network. There is no need to register for each MMS separately as one login ID and one password can be used for all MMS in the network. This eliminates the need to use a credit card to make purchases on any network MMS, the need to set up payment processing with numerous vendors, the need for a MMS to maintain customer database. A single account can be used for all payment processing. Moreover, the processing fees can be reduced as all charges due to a MMS can be aggregated and made in one payment.

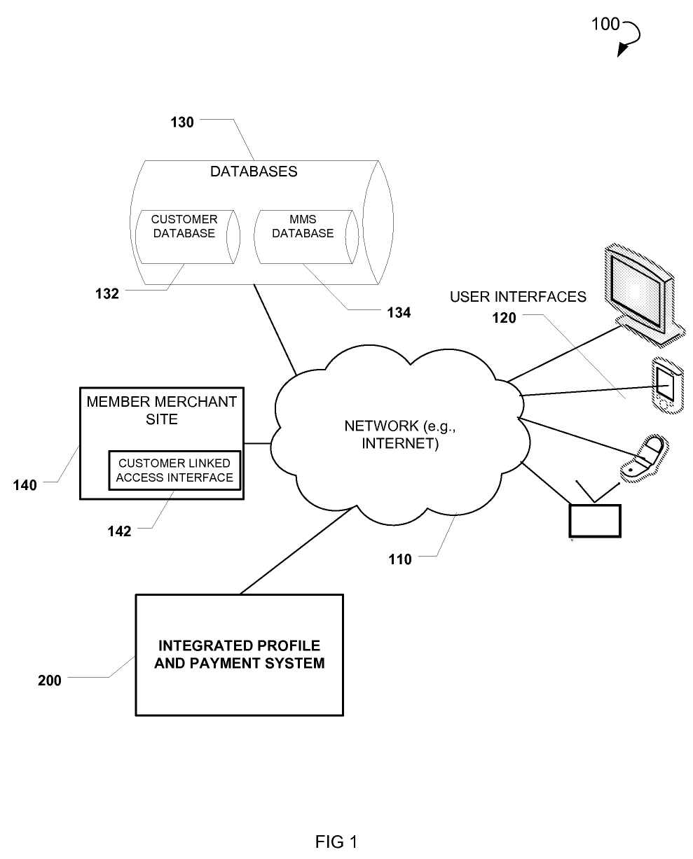

FIG. 1 is a block diagram showing a sample network environment 100 within which a system and method for integrated profile and payment exchange can be implemented, in accordance with an example embodiment. As shown in FIG. 1, the sample network environment 100 may comprise a network 110, user interfaces 120, databases 130, a member merchant site 140, and an electronic trade engine 200. The databases 130 can, in turn comprise a customer database and MMS database. The member merchant site 140 can, in turn, comprise a customer linked access interface 142.

The network 110 can comprise a plurality of data processing nodes interconnected for the purpose of data communication. Other components of the network environment 100 can utilize the network 110 to receive, transmit, and store data as well as for the purpose of accessing remote resources.

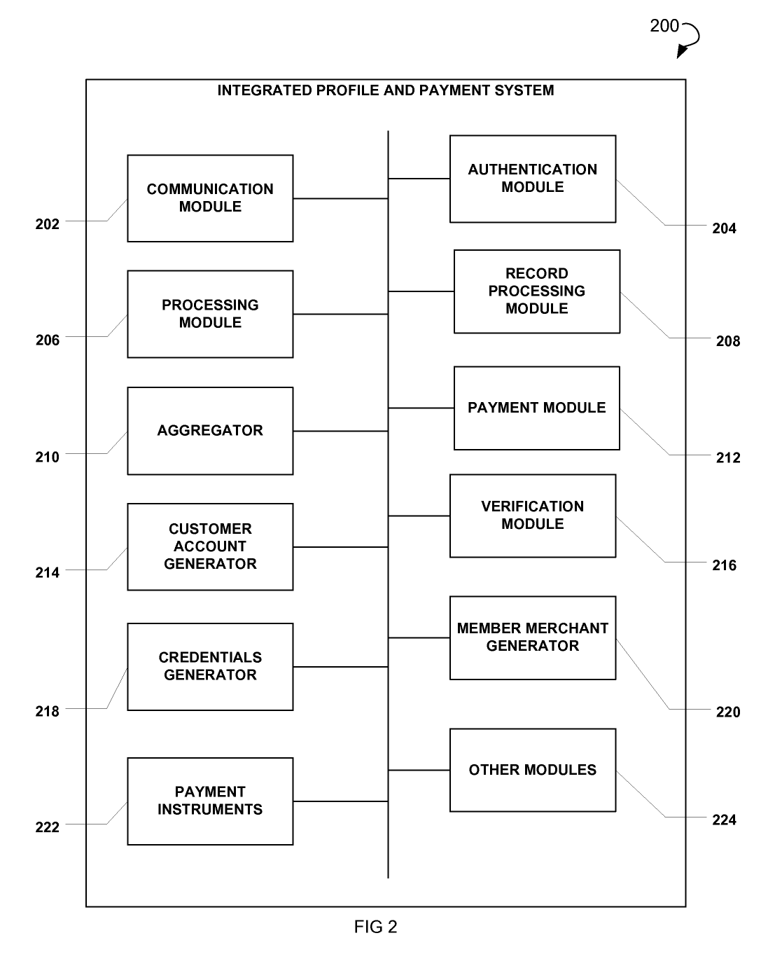

The databases 130 may be utilized to store data processed by the integrated profile and payment system 200 as well as the data processed and by the member merchant site 140. The databases 130 can also store data related to various market participant, which are the parties to the transactions. Such market participants can include merchants, buyers, or any other parties to online transactions. The user interfaces 120 can be included in various devices to facilitate transmitting and receiving data over the network 110. The user interfaces 120 can permit the market participants to interact with the integrated profile and payment system 200. The integrated profile and payment system 200 is described by way of example with reference to FIG. 2.

FIG. 2 is a block diagram showing the integrated profile and payment system 200, in accordance with an example embodiment. The integrated profile and payment system 200 can include several components that may be configured to perform various operations. As show in FIG. 2, the integrated profile and payment system 200 can comprise a communication module 202, an authentication module 204, a processing module 206, a record processing module 208, an aggregator 210, a payment module 212, a customer account generator 214, a verification module 216, a credentials generator 218, a member merchant generator 220, payment instruments 222, and other modules 224.

The communication module 202 can facilitate the receipt and transmission of the information utilized by other modules of the integrated profile and payment system 200. The information can include information communicated during the application process to join the network, information communicated during customer sign up process, information communicated while verifying payment methods with various financial institution, and the information communicated during the login and payment via the customer linked interface 142.

The authentication module 204 can be utilized to authenticate a customer based on the key provided at an MMS or at an IPPEX site. The processing module 206 can be utilized to implement and process the business logic processes of the IPPEX site as well as to perform calculation accompanying these processes. The record processing module 208 can be utilized to access and store records associated with various transactions by engaging in communications with the customer database 132 and the MMS database 134.

The aggregator 210 can be utilized to facilitate payment aggregation by member customer or by MMS. This approach permits reduction in transaction costs. In both cases, the aggregation is optional. For example, the aggregator 210 can be utilized to aggregate payments from multiple user transactions with the same MMS. In another example, a member customer can browse through multiple MMS and make multiple purchases on single or multiple MMS during the course of an aggregation period (e.g. 24 hrs.) At the end of the aggregation period, a single payment can processed in the member customer account for all purchases by the member customer and allocated to the appropriate MMS. This approach can lower the processing cost because only one payment is processed for multiple purchases. The member customer can have an option to request to process the payment immediately if an immediate shipment of product is required.

The payment module 212 can be utilized to charge customer payment accounts and to make payments to a member merchant. The customer account generator 214 can be utilized to generate a customer account based on the profile and payment information provided by the customer. The customer account generator 214 can store the shipping address and instructions in a member customer profile. This information can be communicated to the MMS at the time of a check out. This approach can relieve the customer of having to enter the same information at each MMS. The customer can edit this information at the MMS during the check out process.

The verification module 216 can utilized to verify validity of the payment information provided by the customer. The credentials generator 218 can be utilized to issue a key to a customer upon successful creation of a customer account.

The member merchant generator 220 can be utilized to create a merchant account and provide the merchant with an interface to facilitate customer access. The payment instruments 222 can include credit cards, debit cards, and bank accounts. The other modules 224 can be any other modules that can facilitate functionality of the integrated profile and payment system 200.

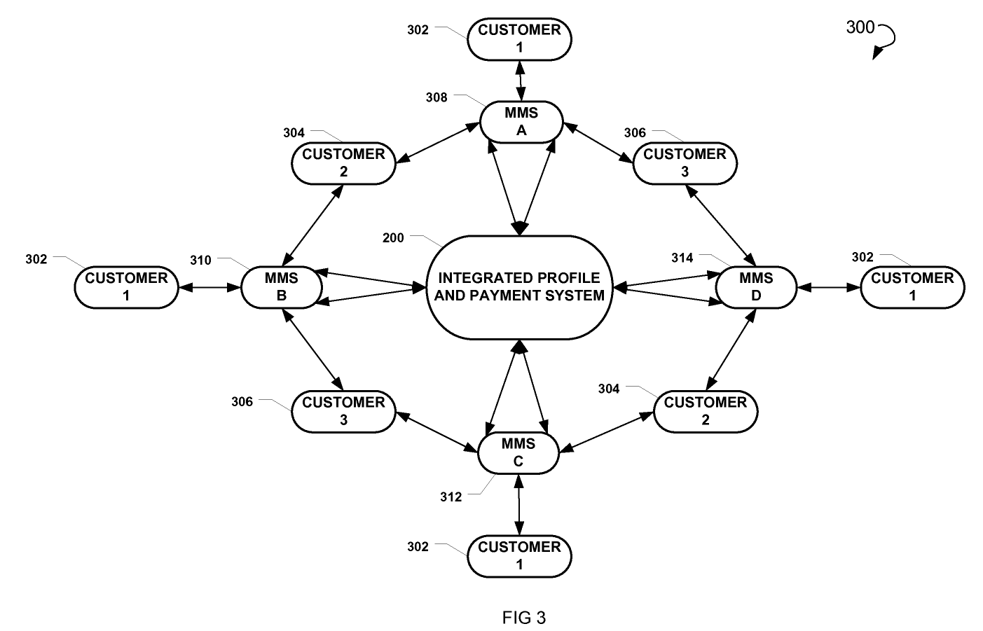

FIG. 3 is a block diagram showing the integrated profile and payment system network 300. The network 300, in an example embodiment, can include the integrated profile and payment system 200, a plurality of customers (1 through 3) and a plurality of MMSs (A through D). As shown in FIG. 3, a customer can access an MMS by providing a key. When customer desires to purchase one or more items at an MMS, a purchase request can be sent to the integrated profile and payment system 200. If the transaction is approved, a purchase approval can be sent to the MMS. This indicates to the MMS that transaction is approved and the one or more items can be sold and shipped to the customer. The integrated profile and payment system 200 can aggregate the payment with other payments made at the MMS and make an aggregate payment to an account associated with the MMS at a later time. In some example embodiments, a customer can move from one MMS to another without having to re-login.

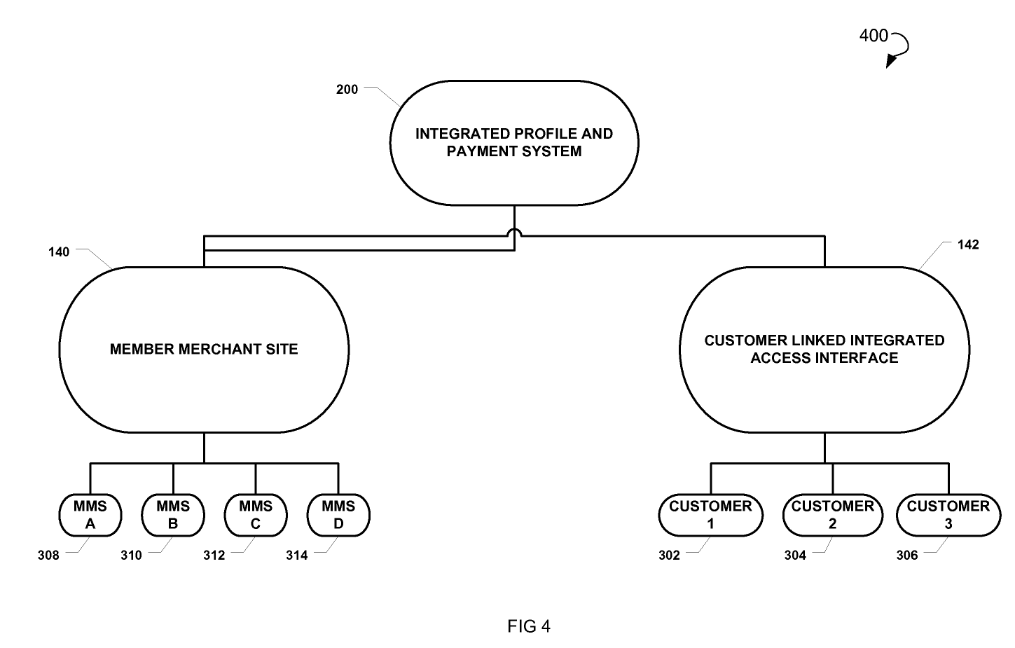

FIG. 4 is a block diagram showing the integrated profile and payment system network 400. As shown in FIG. 4, an MMS can open an account and the account is added to the network of MMS. Thereafter, the MMS payment processing can be linked. Each customer purchasing record is segregated by MMS. A payment to MMS can be made for all purchases by all customers. A customer can open an account with profile and payment information. Once the customer payment information is verified, the account can be maintained. The key can be issued to the customer and the customer network purchases and payment activity can be maintained.

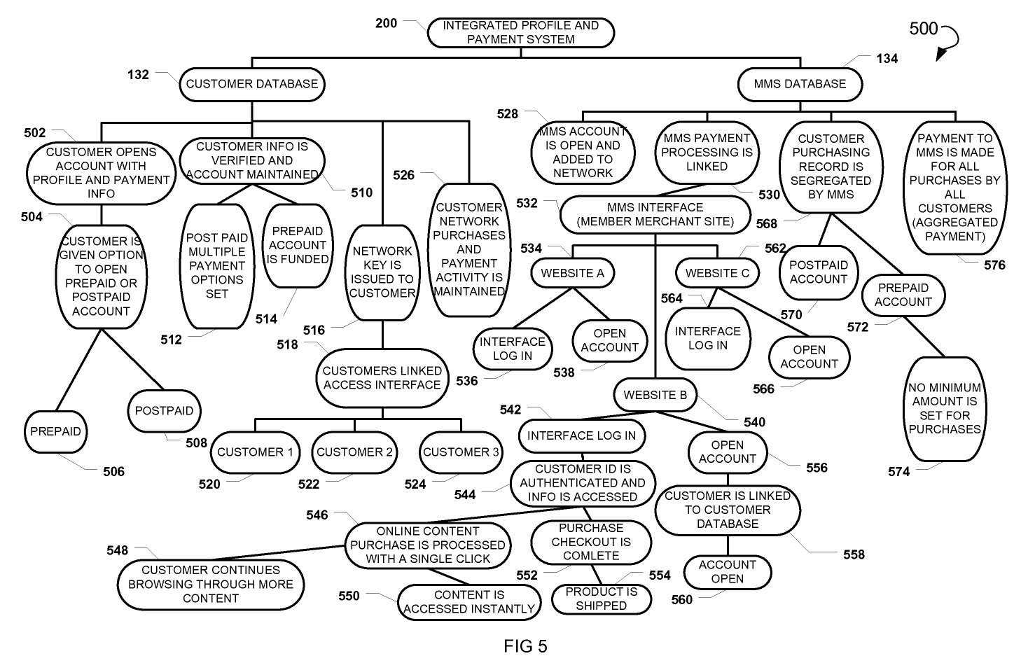

FIG. 5 is a block diagram showing the integrated profile and payment system 500. As shown, the integrated profile and payment system 200 can include two databases, the customer database 132 and the MMS database 134. The MMS database can be utilized to store the information created upon opening an MMS account and adding the MMS to the MMS network. MMS payment processing can be linked at 530 and customer purchasing record can be segregated by MMS at 568. In some example embodiments, the account can be prepaid. Because, no financial transaction needs to take place upon each purchase, there is no minimum limit to the amount of the transaction. Thus, for example, purchases in the amount of 10 cent can be processed. Once a certain amount due to a particular MMS or by a customer on multiple MMS is accumulated, a single payment can be processed for all purchases made. In some example embodiments, the MMS or the customer can specify the criteria by which the purchases are to be processed.

The customer database 134 can be utilized, upon opening a customer account, to store profile and payment information. A customer can be given an option to open prepaid or post paid account. Once the payment information is verified and the account is created the prepaid account can be funded if necessary. In case of the postpaid account, the multiple options can be set. Once the account is created, a key can be issued to the customer and the customer network purchases and payment activity can be maintained and stored in the customer database 132.

Thereafter, the customer can log in into an MMS using the key provided. The successful log in can be made upon authentication of the customer information with integrated profile and payment system 200. Once the authentication is made, the customer can be permitted to complete checkout and the product can be shipped to the customer. Customer continues browsing through more content on the same site or other sites in the network. In some example embodiments, the customer can be permitted to pay for all purchases made at multiple member sites at once.

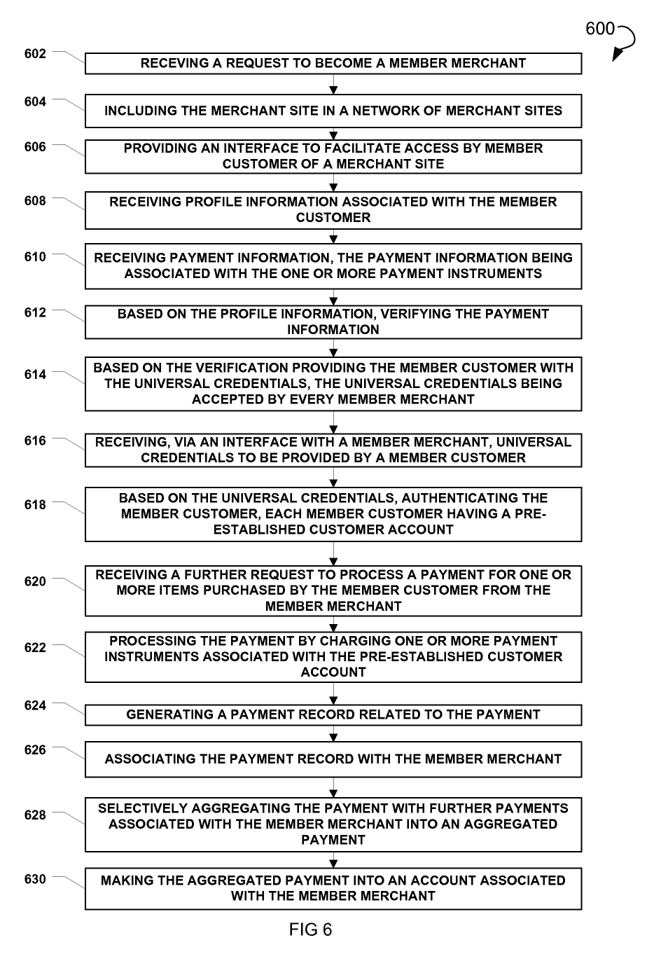

FIG. 6 is a flow chart showing a method 600 for integrated profile and payment system, in accordance with an example embodiment. The method 300 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the electronic trade engine 200 illustrated in FIG. 2.

The method 600 may be performed by the various modules discussed above with reference to FIG. 2. Each of these modules may comprise processing logic. The method 600 may commence at operation 602 with the communication module 202 receiving a request from an MMS to become a member merchant. The request can also include all the requisite application information related to the MMS. Based on the received information, the processing module 206 can determine whether to include the merchant in the network of merchant sites. If the processing module 206 approves the MMS, the merchant is included in a network of merchant sites at operation 604.

At operation 606, the member merchant generator 220 can provide an interface to the MMS. The interface can facilitate access by a member merchant or the MMS. At operation 608, the communication module 202 can receive profile information associated with the member customer. At operation 610, the payment module 212 can receive the payment information. The payment information includes information related to the payment instruments associated with the payment account. At operation 612, based on the profile information, the payment information is verified by the verification module 216. If the verification is successful, at operation 614, the credentials generator 218 can provide the member customer with the universal credentials. The universal credentials can be utilized by the member customer to purchase at the MMS.

When the customer logs in at operation 616, the verification module verifies that universal credentials received via the interface. At operation 618, the authentication module 204 can authenticate the member customer. When the customer attempts to make a purchase, the communication module 202 can receive a further request to process a payment for one or more items purchased by the customer from the MMS at operation 620. At operation 622, the processing module 206 can process the payment by charging one or more payment instruments associated with the pre-established customer account.

At operation 624, the record processing module 208 can generate a payment record related to the payment. The payment record can be segregated by MMS by associating the payment record with the MMS. Thus, at operation 628, the aggregator 210 can selectively aggregate the payment with further payments associated with the member merchant into an aggregated payment. At operation 630 the payment module 212 can make the aggregated payment into an account associated with the member merchant.

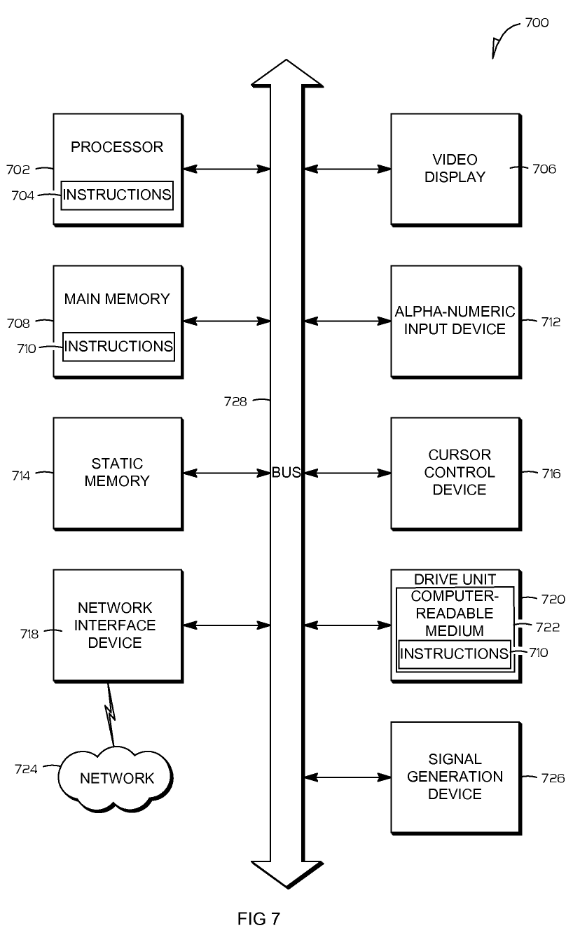

FIG. 7 is a diagrammatic representation of an example machine in the form of a computer system 700, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 702 (e.g., a central processing unit (CPU), a graphics processing unit (GPU), or both), and a main memory 708 and static memory 714, which communicate with each other via a bus 728. The computer system 700 may further include a video display unit 706 (e.g., a liquid crystal display (LCD)). The computer system 700 may also include an alphanumeric input device 712 (e.g., a keyboard), a cursor control device 716 (e.g., a mouse), a voice recognition or biometric verification unit, a disk drive unit 720, a signal generation device 726 (e.g., a speaker) and a network interface device 718. The computer system 700 may further include a data encryption module (not shown) to encrypt data.

The disk drive unit 720 includes a computer-readable medium 722 on which is stored one or more sets of instructions and data structures (e.g., instructions 710) embodying or utilized by any one or more of the methodologies or functions described herein. The instructions 710 may also reside, completely or at least partially, within the main memory 708 and/or within the processors 702 during execution thereof by the computer system 700. The main memory 708 and the processors 702 may also constitute machine-readable media.

The instructions 710 may further be transmitted or received over a network 724 via the network interface device 718 utilizing any one of a number of well-known transfer protocols (e.g., Hyper Text Transfer Protocol (HTTP)).

While the computer-readable medium 722 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer, in hardware, or in a combination of software and hardware.

Thus, methods and systems for integrated profile and payment exchange have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

1. A computer-implemented method, the method comprising:
receiving, via an interface with a member merchant, universal credentials to be provided by a member customer;
based on the universal credentials, authenticating the member customer, each member customer having a pre-established customer account;
receiving a further request to process a payment for one or more items purchased by the merchant customer from the member merchant;
processing the payment by charging one or more payment instruments associated with the pre-established customer account;
generating a payment record related to the payment;
associating the payment record with the member merchant;
selectively aggregating the payment with further payments associated with the member merchant into an aggregated payment; and
making the aggregated payment into an account associated with the member merchant.

2. The computer-implemented method of claim 1, further comprising aggregating the payment with further payments associated with the member customer, the further payments due to one or more member merchants.

3. The computer-implemented method of claim 1, wherein creation of the pre-established customer account comprises:
receiving profile information associated with the member customer;
receiving payment information, the payment information being associated with the one or more payment instruments;
based on the profile information, verifying the payment information; and
based on the verification providing the member customer with the universal credentials, the universal credentials being accepted by every member merchant.

4. The computer-implemented method of claim 3, further comprising receiving shipping information and instructions associated with the member customer.

5. The computer-implemented method of claim 3, wherein the universal credentials include a secure access key.

6. The computer-implemented method of claim 3, wherein the pre-established customer account is created via the merchant site.

7. The computer-implemented method of claim 1, wherein becoming the member merchant comprises:
providing an interface to facilitate access by the member customer of a merchant site associated with the member merchant; and
including the merchant site in a network of merchant sites.

8. The computer-implemented method of claim 1, wherein the one or more payment instruments include one or more of the following: a credit card, a debit card, a bank account, and a pre-funded account.

9. The computer-implemented method of claim 1, wherein the pre-established account is pre-funded with the one or more of the payment instruments.

10. The computer-implemented method of claim 1, wherein the payment is not limited by a predetermined minimum amount.

11. A computer-implemented integrated profile and payment system, the system comprising:
a communication module to receive, via an interface with a member merchant, universal credentials to be provided by a member customer;
an authentication module to authenticate the member customer based on the universal credentials, each member customer having a pre-established customer account;
the communication module to further receive a further request to process a payment for one or more items purchased by the merchant customer from the member merchant;
a processing module to process the payment by charging one or more payment instruments associated with the pre-established customer account;
a record processing module to generate a payment record related to the payment and to associate the payment record with the member merchant;
an aggregator to selectively aggregate the payment with further payments associated with the member merchant into an aggregated payment; and
a payment module to make the aggregated payment into an account associated with the member merchant.

12. The computer-implemented method of claim 11, further comprising a customer account generator to create pre-established customer account, the customer account generator comprising:
the communication module to receive profile information associated with the member customer and to receive payment information, the payment information being associated with the one or more payment instruments;
a verification module to verify the payment information based on the profile information; and
a credentials generator to provide the member customer with the universal credentials based on the verification, the universal credentials being accepted by every member merchant.

13. The computer-implemented method of claim 12, wherein the communication module is to send shipping information and instructions being associated with the customer profile.

14. The computer-implemented system of claim 12, wherein the credentials generator generates a secure access key.

15. The computer-implemented system of claim 12, wherein the pre-established customer account is created via the merchant site or an IPPEX site.

16. The computer-implemented system of claim 11, further comprising a member merchant generator to provide an interface to facilitate access by the member customer of a merchant site associated with the member merchant and including the merchant site in a network of merchant sites.

17. The computer-implemented system of claim 11, wherein the one or more payment instruments include one or more of the following: a credit card, a debit card, and a back account.

18. The computer-implemented system of claim 11, wherein the pre-established account is pre-funded with the one or more of the payment instruments.

19. The computer-implemented system of claim 11, wherein the payment is not limited by a predetermined minimum amount.

20. A machine-readable medium comprising instructions, which when implemented by one or more processors, perform the following operations:
receive, via an interface with a member merchant, universal credentials to be provided by a member customer;
authenticate the member customer based on the universal credentials, each member customer having a pre-established customer account;
receive a further request to process a payment for one or more items purchased by the member customer from the member merchant;
process the payment by charging one or more payment instruments associated with the pre-established customer account;
generate a payment record related to the payment;
associate the payment record with the member merchant;
selectively aggregate the payment for purchases associated with the member customer account;
selectively aggregate the payment with further payments associated with the member merchant into an aggregated payment; and
make the aggregated payment into an account associated with the member merchant.
